(19) United States
(12) Patent Application Publication
(10) Pub. No.: US 2011/0033689 A1
(43) Pub. Date: Feb. 10, 2011

(54) PRODUCTION METHOD FOR THE MANUFACTURING OF VERY THIN MONOLITHIC LAYERS OF THERMOPLASTIC POLYURETHANE AND PRODUCT COMPOSITIONS DERIVED FROM SUCH LAYERS

(76) Inventors: Boeykens Ivan, Merksem (BE); Van Edom Bart, Scherpenheuvel-Zichem (BE); Vanhoof Mieke, Berchem (BE)

Correspondence Address: BACON & THOMAS, PLLC, 625 SLATERS LANE, FOURTH FLOOR, ALEXANDRIA, VA, 22314-1176, US

(21) Appl. No.: 12/851,027

(22) Filed: Aug. 5, 2010

(30) Foreign Application Priority Data
Aug. 6, 2009 (EP) 09447035.8

(51) Int. Cl. B32B 27/40; B29C 47/02

(52) U.S. Cl. 428/220; 264/171.13; 428/334

(57) ABSTRACT

Production method for the manufacturing of very thin monolithic layers of thermoplastic polyurethane (TPU) characterized in that the TPU is extrusion coated and/or laminated with an extrusion head with a mouth opening of less than 0.80 mm, and preferably of 0.60 mm, whereby the line speed is held between 50 m/min and 200 m/min, and preferably at 100 m/min, and whereby the extruder head temperature is held between 150° C. and 270° C., and preferably at 175° C., and whereby the extruder compression ratio is held between 3.0 and 3.8, and preferably at 3.5, and whereby the pressing pressure of the extruder is kept between 10 bar and 80 bar, and preferably at 40 bar.

The present invention relates to a production method for the manufacturing of very thin monolithic layers of thermoplastic polyurethane and of product compositions derived from such layers.

Thermoplastic polyurethane (TPU) combines a high resistance to UV irradiation and a high resistance to mechanical wear and tear with impermeability for water and gases, when applied in thin layers and this for several application domains.

Thin monolithic layers of TPU are traditionally obtained by coating from solvent, or by extrusion techniques whereby TPU is coextruded onto a carrier material or substrate.

A disadvantage of the known production method of coating TPU from solvent is that this production method is expensive and environmentally unfriendly.

A disadvantage of thin monolithic layers of TPU is that they are not very permeable to water vapor unless their thickness is reduced to very thin layers of less than 100 micrometer thickness.

Another disadvantage of thin monolithic layers of TPU is that the material cost of these layers is relatively high, since PU is an expensive chemical.

The present invention aims at countering these disadvantages by enabling the production of very thin layers of TPU by an appropriate extrusion technique.

To this end, TPU is extruded or extrusion coated and/or laminated with an extrusion head with a mouth opening of less than 0.80 mm, and preferably of 0.60 mm, whereby the extrusion speed in the line is held between 50 m/min and 200 m/min, and preferably at 100 m/min, and whereby the extruder head temperature is held between 150° C. and 270° C., and preferably at 175° C., and whereby the extruder compression ratio is held between 3.0 and 3.8, and preferably at 3.5, and whereby the pressing pressure of the extruder is kept between 10 bar and 80 bar, and preferably at 40 bar.

The high transmission speed and the other extrusion parameters result in the prevention of polymer chain scission which prevents layer breakage and disintegration which would normally be expected for these very thin layers, so that a stable monolithic and continuous very thin layer of TPU is formed with a thickness of 8 to 100 micrometer, and more preferably a thickness of 30 to 60 micrometer.

An advantage of these very thin layers of monolithic TPU is that they are permeable to water vapor with a transmission rate for water vapor of 600-4000 g/m²/day.

Another advantage of these very thin layers of TPU is that the cost of the PU chemical is reduced due to the very low thickness.

Another advantage of the very thin layers of monolithic TPU produced in this way is that they do not show discontinuities in the layer and as such can be incorporated into products.

Another advantage of these very thin monolithic layers of TPU is that their resistance to UV irradiation and to mechanical wear remains intact.

With the intention to better show the features of the invention a preferred embodiment is described of an extrusion equipment for the production of very thin TPU layers according to the invention, with reference to the accompanying figures, wherein:

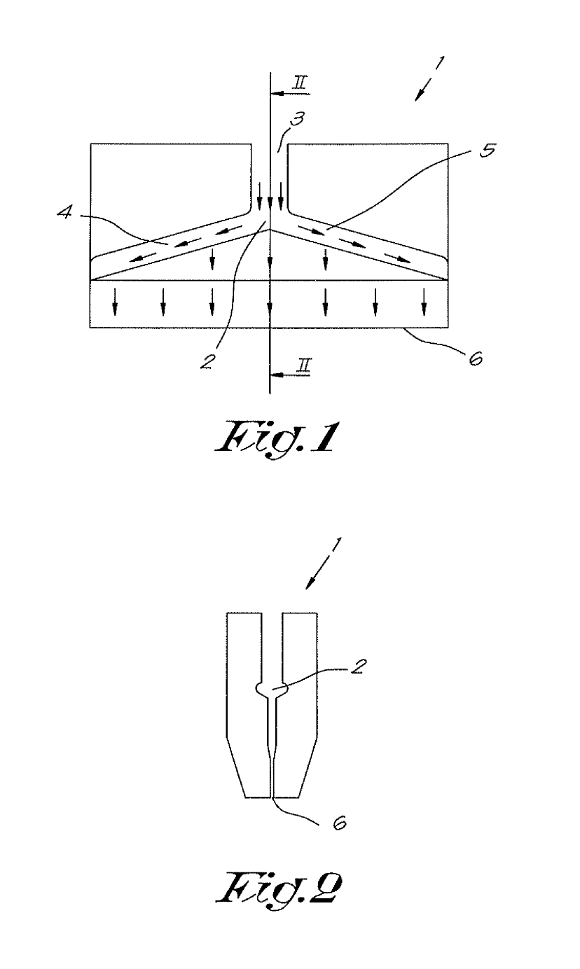

FIG. 1 schematically represents a frontal view of an extrusion head used to produce very thin layers of TPU according to the invention;

FIG. 2 represents a cross section according to line II-II of FIG. 1;

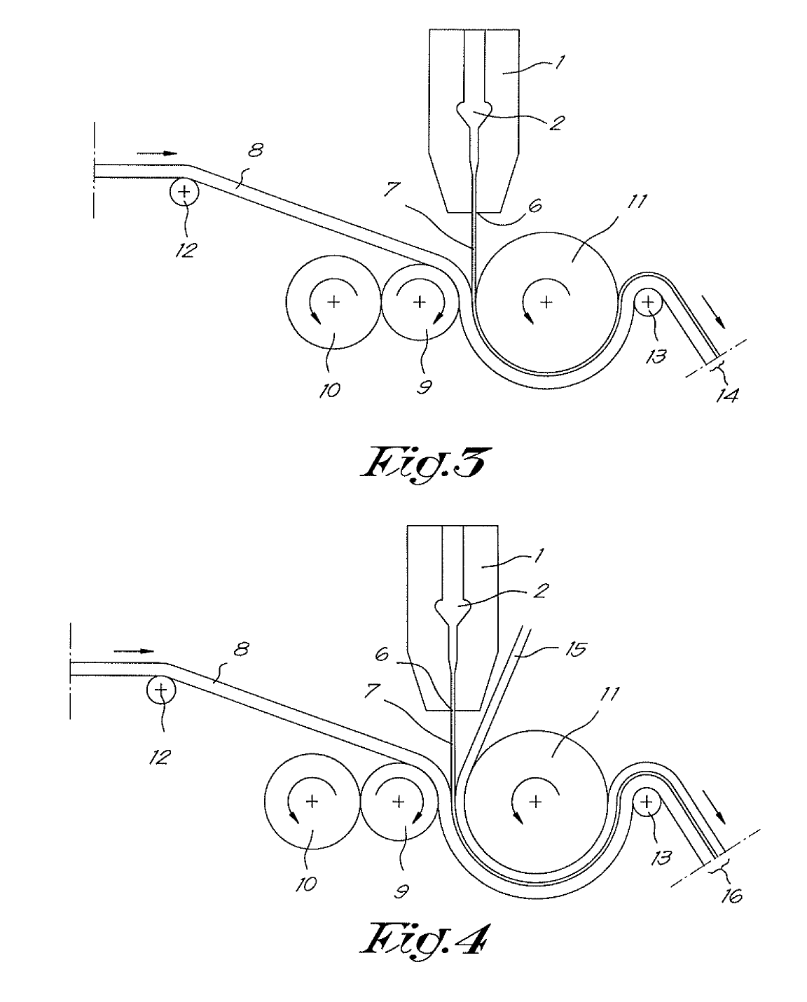

FIG. 3 schematically represents a cross section of an extrusion coating equipment using the extrusion head of FIGS. 1 and 2;

FIG. 4 schematically represents a cross section of an extrusion lamination equipment using the extrusion head of FIGS. 1 and 2.

The extrusion head represented in FIGS. 1 and 2 is of a known type with a distribution chamber 2 in the shape of a coat hanger with an inlet 3 for molten polymer and two branches 4,5 which are slanting down and which are communicating with an outlet in the shape of a thin narrow slit 6 extending over the width of the coat hanger type distribution chamber 2 of the extrusion head 1.

The functioning of the extrusion head 1 in FIG. 1 is simple and as follows. The thermoplastic polyurethane (TPU) is molten in the extrusion head 1 at a temperature of between 150° C. and 270° C. and more preferably of 175° C., after which the polymer is guided through the inlet 3 of the distribution chamber 2 of the coat hanger extrusion head 1, and subsequently through the coat hanger shaped arms 4,5 of the distribution chamber 2.

The polymer is subsequently guided as a very thin layer through the extrusion mouth with an adjustable die 6 that has been adjusted to a die opening of less than 800 micrometer (or 0.8 mm), and preferably of 600 micrometer.

The extrusion speed of the polymer through the extrusion head has to be sufficiently high, namely between 50 to 200 m/min, and most preferably of 100 m/min as measured at the counter cooling roller 11.

In FIG. 3 an extrusion coater is represented with an extrusion head 1 and a molten polymer 7, a substrate 8 and a pressure roller 9 with a back-up roller 10, a cooling counter pressure roller 11 and guidance rollers 12 and 13 as used in the manufacturing of a very thin TPU based product 14 according to the invention.

The functioning of the extrusion coater in FIG. 3 can be explained as follows. The molten polymer 7 flows as a relatively thick film from the extrusion head 1 and is, in the distance from the extruder head to the nip, stretched to the very thin thickness of 8 to 100 micrometer, preferably of 30 to 60 micrometer. The film is then fused by a pressure roller 9 backed by another roller 10 to a substrate 8, supported by a guidance roller 12, onto one side of the molten polymer layer 7 whereby a cooling roller 11 exerts counter pressure and cools and hardens the molten film, after which the finished product 14 leaves the production process supported by another guidance roller 13.

In FIG. 4 an extrusion laminator is represented with an extrusion head 1 and a molten polymer 7, two substrate layers 8 and 15, a pressure roller 9 with back-up roller 10, a cooling counter pressure roller 11 and guidance rollers 12 and 13 as used in the manufacturing of a very thin TPU based laminated product 16 according to the invention.

The functioning of the extrusion laminator in FIG. 4 can be explained as follows. The molten polymer 7 flows as a relatively thick film from the extrusion head 1 and is, in the distance from the extruder head to the nip, stretched to the very thin thickness of 8 to 100 micrometer, preferably of 30 to 60 micrometer. The film is then fused by the pressure roller 9 onto two substrates 8 and 15, on both sides of the molten polymer layer 7 whereby a cooling roller 11 exerts counter pressure and cools and hardens the molten film, after which the finished product 16 leaves the production process, supported by guidance roller 13.

The substrates 8,15 coated with a very thin TPU layer can be diverse: porous or nonporous materials, woven or nonwoven polymer, fibers and filaments, film, metalized film, aluminum, paper, scrim, glass fiber tissue, textile and other materials.

These materials, containing a very thin TPU layer find applications in many domains: building, clothing, technical textiles, medical cover sheets, mattress protection, personal hygiene products and this for breather and non breather membrane products.

The present invention is in no way limited to the embodiments described in the figures, but such a production method for the production of such very thin TPU layers and the incorporation of these layers in end products can be applied in several embodiments, without leaving the scope of the invention.

1-8. (canceled)

9. Method for making very thin monolithic layers of thermoplastic polyurethane (TPU), comprising the steps: extruding or extrusion coating and/or laminating the TPU with an extrusion head having a mouth opening of less than 0.80 mm, with an extrusion speed between 50 m/min and 200 m/min, with the extruder head at a temperature between 150° C. and 270° C., with the extruder compression ratio being between 3.0 and 3.8, and with the pressing pressure of the extruder being between 10 bar and 80 bar.

10. Method according to claim 9, including forming a continuous monolithic extruded layer of TPU with a thickness of less than 100 micrometer.

11. Method according to claim 9, including forming a continuous monolithic extruded layer of TPU with a thickness from 8 to 100 micrometer.

12. Method according to claim 9, including fusing the extruded very thin layer of TPU to a substrate layer by means of an extrusion coater having a pressure cylinder and a cooling counter pressure cylinder.

13. Method according to claim 9, including fusing the extruded very thin layer of TPU between two substrate layers on the front and back side respectively of the TPU layer by an extrusion lamination process using a pressure cylinder and a cooling counter pressure cylinder.

14. Monolithic layer of TPU, comprising an extruded very thin layer with a thickness of less than 100 micrometer.

15. A product comprising a very thin layer according to claim 14.

16. A product according to claim 15, wherein the very thin layer is fused on at least one side to a substrate.
